(19) United States
(12) Patent Application Publication
(10) Pub. No.: US 2026/0366707 A1
(43) Pub. Date: Nov. 19, 2026

(54) STAGE LIGHT FIXTURE WITH METAL MOUNTING BASE

(71) Applicant: Guangzhou Haoyang Electronic Co., Ltd., Guangzhou (CN)

(72) Inventors: Weikai JIANG, Guangzhou (CN); Weiquan JIANG, Guangzhou (CN); Zhiqiang CHEN, Guangzhou (CN); Mingfu LIAO, Guangzhou (CN)

(21) Appl. No.: 19/403,438

(22) Filed: Nov. 28, 2025

(30) Foreign Application Priority Data
May 17, 2025 (CN) 202520981684.1

(51) Int. Cl. F21V 17/16; F21V 9/40; F21V 29/89; F21W 131/406

(52) U.S. Cl. CPC F21V 17/168; F21V 9/40; F21V 29/89; F21V 2200/40; F21W 2131/406

(57) ABSTRACT

A light conducting assembly includes a light conductor for conducting a light beam, and a metal mounting support having a through hole, where the light conductor is accommodated in the through hole, and the metal mounting support is provided an elastic clamping member or clamping the light conductor to prevent the light conductor from shaking.

### CROSS REFERENCE TO RELATED APPLICATIONS

The present application claims priority from Chinese Application No. CN 202520981684.1 filed on May 17, 2025, all of which are hereby incorporated herein by reference.

### TECHNICAL FIELD

The present disclosure relates to the technical field of stage light fixtures, and more particularly, to light conducting assembly with a metal mounting base and a stage light fixture having the same.

### BACKGROUND

In the field of lighting technology, a light conductor is generally provided to uniformly mix light emitted by a light source. The light is reflected inside the light conductor to achieve a uniform light mixing effect, thereby forming a light beam with uniform brightness and color. For this purpose, the light conductor is required not to fall off from the light fixture during rotation. A holder is typically used to fix the light conductor, which is generally made of plastic material. However, the light conductor is usually positioned in a high-temperature area inside the stage light fixture, and the plastic holder tends to release various decomposition products at high temperature, which does not meet the environmental protection requirements. In addition, such decomposition products will adhere to the surface of the light conductor, resulting in poor light effects.

### SUMMARY

The present disclosure therefore provides an improved light conducting assembly and a stage light fixture including the same, which are free from the above-mentioned problems.

In a first aspect of the present disclosure, a light conducting assembly is provided, which includes a light conductor for conducting a light beam; and a metal mounting support having a through hole, where the light conductor is accommodated in the through hole, and the metal mounting support is provided an elastic clamping member or clamping the light conductor to prevent the light conductor from shaking.

According to the present disclosure, with the configuration of the metal mounting support for accommodating the light conductor, decomposition products will not be released due to high-

temperature decomposition during conducting of the high-brightness light beam, as the metal mounting support can undergo higher temperature. Accordingly, the light conducting assembly of the present embodiment can eliminate generation of non-environmentally-friendly substances and avoid adhesion of plastic decomposition products to the light conductor, which ensures light transmittance of the light beam, as well as improving environmental protection performance of the stage light fixture including the light conducting assembly.

According to an advantageous embodiment of the present disclosure, to ensure fixing stability of the light conductor and prevent it from shaking, two elastic clamping members may be provided, which are sequentially disposed along the length direction of the light conductor.

In a preferable embodiment, as stepped structure is simple to design and easy to process, the inner side wall of the mounting support may be recessed to form a stepped portion for mounting the elastic clamping member. Such stepped portion also has positioning and limiting functions to provide guidance for mounting of the elastic clamping members.

Due to elastic deformation characteristics, an elastic ring can continuously provide an adaptively adjustable acting force and thus compensate the mounting error during assembly. Therefore, the elastic clamping member in a preferable embodiment may be designed in form of the elastic ring, with the inner side of the elastic ring abutted against the light conductor, and the outer side of the elastic ring abutted against the side wall of the stepped portion.

More preferably, the elastic clamping member is in form of a scalable wave ring including a plurality of wave peaks abutted against the side wall of the stepped portion and wave troughs abutted against the light conductor. The scalable wave ring has high elastic coefficient, which thus can enhance the tightness of contact between the light conductor and the stepped portion.

According to a preferable embodiment of the present disclosure, a pressing base arranged on the mounting support may be further provided, where a bottom end of the pressing base is abutted against the end of the elastic clamping member to fix the elastic clamping member, and the pressing base is provided with a first light-transmitting hole corresponding to the light conductor. With such configuration, the elastic clamping member can be further prevented from falling off, while allowing the light beam to pass through.

Furthermore, metal is resistant to high temperature, therefore, both the elastic clamping member and the pressing base are made of metal. This can further prevent release of contaminants in high-temperature environments.

Additionally or alternatively, the light conducting assembly may further include an optical effect sheet covering the first light-transmitting hole, where an end face of the pressing base away from the elastic clamping member may be recessed to form an accommodating groove, and the optical effect sheet may be placed in the accommodating groove. The cooperation of the light conductor and the optical effect sheet can enhance artistic expression of the light beam. In addition, the accommodating groove accommodating the optical effect sheet provides positioning guidance for mounting of the optical effect sheet.

More preferably, the optical effect sheet may be a diffusion sheet, which can achieve light diffusion and thus further improve uniformity of the light beam.

Additionally, a fixing sleeve sleeved outside the mounting support may be further provided, where the end of the fixing sleeve may be abutted against the pressing base, and the fixing sleeve may be provided with a second light-transmitting hole corresponding to the light conductor. The fixing sleeve can fix the pressing base and further prevent it from falling off.

In another aspect of the present disclosure, a stage light fixture is provided, which includes a light head, a support arm pivotally connected to the light head, and a base pivotally connected to the support arm, where the light head is internally provided with a light source for emitting a light beam, and the light conducting assembly in any cases mentioned above is arranged in the propagating direction of the light beam.

### BRIEF DESCRIPTION OF THE DRAWINGS

FIG. 1 is a perspective view of a light conducting assembly according to an embodiment of the present disclosure;

FIG. 2 is a disassembly view of the light conducting assembly in FIG. 1;

FIG. 3 is a cross-sectional view of FIG. 1;

FIG. 4 is a view showing a light conductor and elastic clamping members according to the present disclosure;

FIG. 5 is a perspective view of a stage light fixture according to an embodiment of the present disclosure; and

FIG. 6 is a perspective view of a light head of the stage light fixture in FIG. 5, with some parts removed.

### DETAILED DESCRIPTION OF THE EMBODIMENTS

The drawings are merely for illustrative purposes and should not be interpreted as limitations to this patent. To better illustrate the embodiments, some components in the drawings may be omitted, enlarged, or reduced, and do not represent the actual size of the product. For those skilled in the art, it can be understood that some well-known structures and their descriptions may be omitted in the drawings. The positional relationships depicted in the drawings are for illustrative purposes only and are not to be construed as limiting this patent.

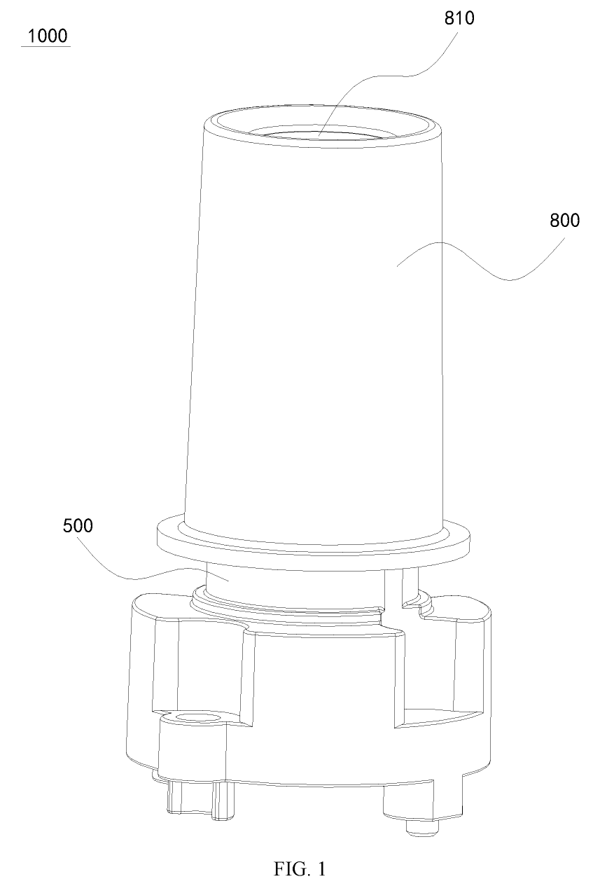

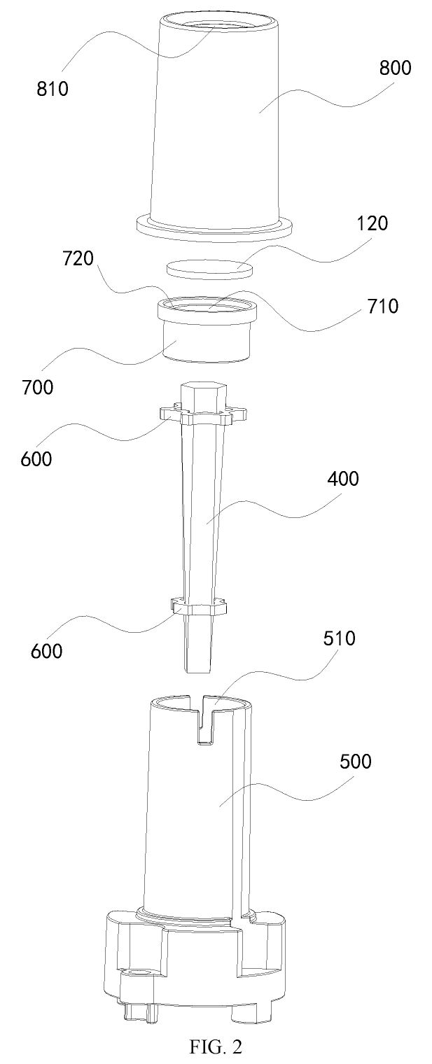

FIGS. 1 and 2 provide a light conducting assembly 1000, especially for a stage light fixture, according to an embodiment of the present disclosure. The light conducting assembly 1000 of the present embodiment includes a light conductor 400 and a metal mounting support 500 for holding the light conductor 400. The metal mounting support 500 has a through hole 510 in which the light conductor 400 is accommodated. At least one elastic clamping member 600 is further provided in the metal mounting support 500 to clamp the light conductor 400, so as to prevent the light conductor 400 from shaking, especially during rotation.

The light conductor 400 is usually used for improving uniformity of the light beam with high brightness. However, the high-brightness light beam generates extremely intense heat when passing through the light conductor 400. With the metal mounting support 500 for accommodating the light conductor 400 in the present embodiment, decomposition products will not be released due to high-temperature decomposition, as the metal mounting support 500 can undergo higher temperature. Accordingly, the light conducting assembly 1000 of the present embodiment can eliminate generation of non-environmentally-friendly substances and avoid adhesion of plastic decomposition products to the light conductor 400, thereby ensuring light transmittance of the light beam, as well as improving environmental protection performance of the stage light fixture.

As shown in FIG. 2, two elastic clamping members 600 are particularly provided in the present embodiment. Two elastic clamping members 600 can ensure fixing stability of the light conductor 400 and prevent it from shaking.

In this embodiment, the light conductor 400 has an upper end in a hexagonal shape and a lower end in a quadrilateral shape.

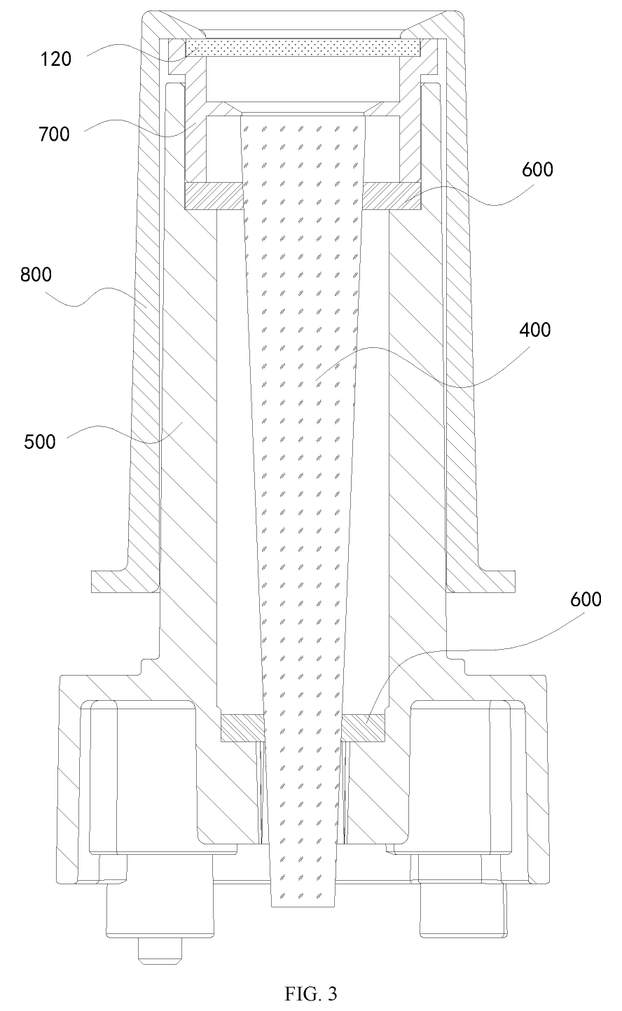

Referring to FIG. 3, the inner side wall of the mounting support 500 in the present embodiment is recessed to form stepped portions 520, on which the elastic clamping members 600

are respectively positioned. The structure of stepped portions has advantageous of simple design and easy processing, also has positioning and limiting functions, so as to provide guidance for mounting of the elastic clamping members 600.

In the present embodiment, the inner side wall of the mounting support 500 is provided with two stepped portions 520 corresponding to the two elastic clamping members 600.

Alternatively, the elastic clamping members 600 can be fixedly arranged on the inner side wall of the mounting support 500 by adhesive.

As shown in FIG. 2, the elastic clamping members 600 in this embodiment are elastic rings, inner side of each elastic ring is abutted against the light conductor 400, and outer side of each elastic ring is abutted against side wall of the corresponding stepped portion 520. The elastic rings, used as fixing bridges between the light conductor 400 and the side walls of the stepped portions 520, have elastic deformation characteristics, which can continuously provide an adaptively adjustable acting force and thus compensate the mounting error during assembly.

Preferably, the inner side of each elastic ring is partially abutted against the light conductor 400. This can improve elastic deformation capability of the elastic ring.

Similarly, the outer side of each elastic ring is preferably partially abutted against the side wall of the corresponding stepped portion 520, which further improves the elastic deformation capability of the elastic ring.

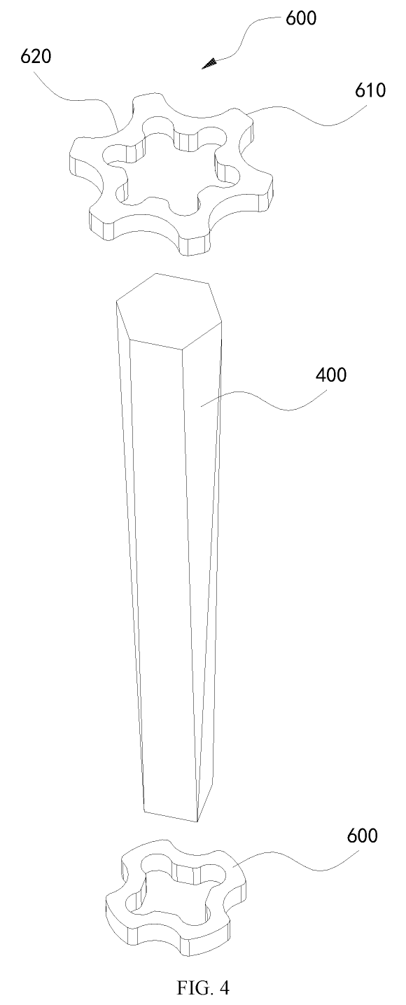

As shown in FIG. 4, each elastic clamping member 600 in this embodiment is in form of a scalable wave ring having a plurality of wave peaks 610 and wave troughs 620. The wave troughs 620 of the scalable wave ring are abutted against the light conductor 400, and the wave peaks 610 of the scalable wave ring are abutted against the side wall of the stepped portion 520. The scalable wave ring has high elastic coefficient, which thus enhances the tightness of contact between the light conductor 400 and the stepped portion 520.

In this embodiment, two scalable wave rings are provided, and the number of the wave peak 610 and the number of the wave troughs 620 of each of the scalable wave rings correspond to the number of side faces of the light conductor 400.

Particularly, one scalable wave ring has six wave peaks 610 and six wave troughs 620 corresponding to the hexagonal shape of the upper end of the light conductor 400.

In addition, one scalable wave ring has four wave peaks 610 and four wave troughs 620

corresponding to the quadrilateral shape of the lower end of the light conductor 400.

Referring back to FIGS. 2 and 3, the light conducting assembly 1000 further includes a pressing base 700 disposed on the mounting support 500, with the bottom end of the pressing base 700 abutted against the upper end of e the elastic clamping member 600 at the upper end of the light conductor 400 to fix the elastic clamping member 600, and the pressing base is provided with a first light-transmitting hole 710 corresponding to the light conductor 400. The pressing base 700 abutted against the elastic clamping member 600 further prevents elastic clamping member 600 from falling off, and the first light-transmitting hole 710 allows the light beam to pass through. In this embodiment, only one pressing base 700 is provided for the elastic clamping member 600 at the upper end of the light conductor 400. However, it is conceivable that in other embodiments a pressing base 700 may be provided for each elastic clamping member 600.

In an alternative embodiment, the light conductor 400 may be inserted into the elastic clamping members 600 for fixation.

In the present embodiment, both the elastic clamping members 600 and the pressing base 700 are made of metal. The metal is resistant to high temperature, thereby preventing release of contaminants in high-temperature environments.

Alternatively, the elastic clamping members 600 and/or the pressing base 700 may also be made of plastic.

As shown in FIGS. 2 and 3, the light conductor assembly further includes an optical effect sheet 120 covering the first light-transmitting hole 710. The upper end face of the pressing base 700 is recessed to form an accommodating groove 720, and the optical effect sheet 120 is received in the accommodating groove 720. The cooperation of the light conductor 400 and the optical effect sheet 120 enhances artistic expression of the light beam, and the accommodating groove 720 accommodating the optical effect sheet 120 further provides positioning guidance for mounting of the optical effect sheet 120.

The optical effect sheet 120 in this embodiment is a diffusion sheet, which achieves diffusion of the light beam and thus improves uniformity of the light beam.

As shown in FIGS. 1-3, the light conductor 400 in the present embodiment further includes a fixing sleeve 800 sleeved outside the mounting support 500, with the end of the fixing sleeve 800 abutted against the pressing base 700. The fixing sleeve 800 is provided with a second light- transmitting hole 810 corresponding to the light conductor 400. The fixing sleeve 800 in the present embodiment is configured to fasten the pressing base 700 and thus prevent the pressing base 700 from falling off.

The fixing sleeve 800 in this embodiment is made of metal.

In addition, an outer edge of the pressing base 700 is flush with an outer edge of the mounting support 500.

Furthermore, an edge of the second light-transmitting hole 810 extends to form a fixing chamfer for fixing the diffusion sheet, so as to prevent the diffusion sheet from falling off.

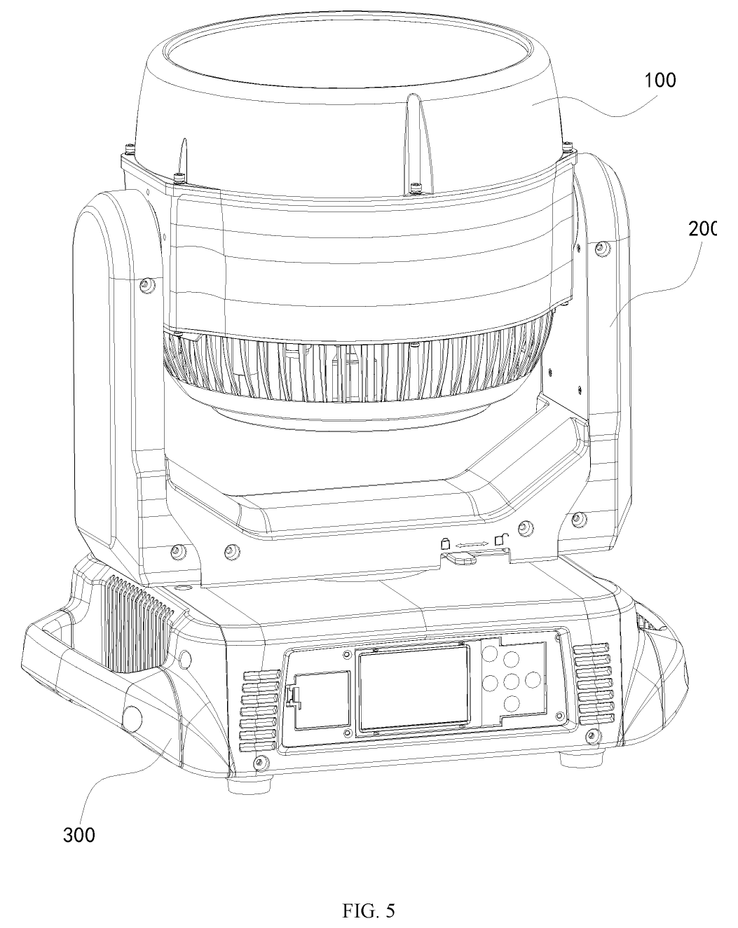

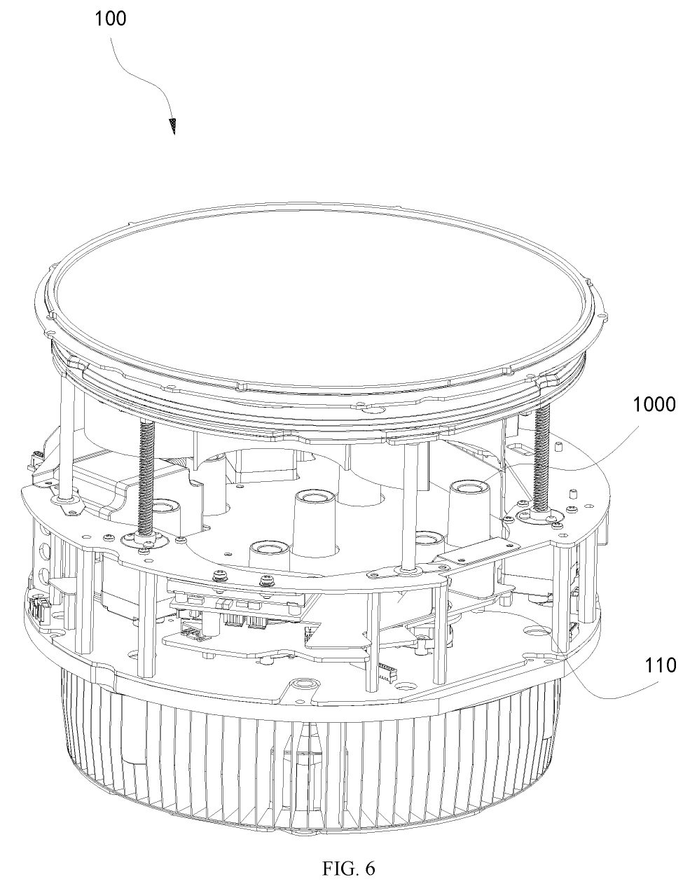

FIG. 5 provides a stage light fixture according to an embodiment of the present disclosure. The stage light fixture in this embodiment includes a light head 100, a support arm 200 pivotally connected to the light head 100, and a base 300 pivotally connected to the support arm 200. As shown in FIG. 6, the light head 100 is internally provided with a plurality of light sources 110 for emitting light beams. The light conducting assembly 1000 mentioned above is arranged in the propagating direction of the light beam emitted by each light source 110.

Apparently, the above embodiments of the present disclosure are only examples provided to clearly illustrate the present disclosure, and are not limitations on the implementations of the present disclosure. For those of ordinary skill in the art, various other forms of modifications or changes can be made on the basis of the above description. It is neither necessary nor possible to enumerate all embodiments herein. Any modifications, equivalent replacements, improvements, etc. made within the spirit and principle of the present disclosure shall be included within the scope of protection of the claims of the present disclosure.

What is claimed is:

1. A light conducting assembly for a stage light fixture, comprising:
a light conductor for conducting a light beam; and
a metal mounting support having a through hole, the light conductor being accommodated in the through hole, wherein the metal mounting support is provided an elastic clamping member for clamping the light conductor to prevent the light conductor from shaking.

2. The light conducting assembly according to claim 1, wherein two elastic clamping members are provided, which are sequentially disposed along a length of the light conductor.

3. The light conducting assembly according to claim 1, wherein an inner side wall of the mounting support is recessed to form a stepped portion for mounting the elastic clamping member.

4. The light conducting assembly according to claim 3, wherein the elastic clamping member is in form of an elastic ring, with an inner side of the elastic ring abutted against the light conductor, and an outer side of the elastic ring abutted against a side wall of the stepped portion.

5. The light conducting assembly according to claim 4, wherein the elastic clamping member is in form of a scalable wave ring including a plurality of wave peaks abutted against the side wall of the stepped portion and wave troughs abutted against the light conductor.

6. The light conducting assembly according to claim 1, further comprising a pressing base arranged on the mounting support, wherein a bottom end of the pressing base is abutted against an end of the elastic clamping member to fix the elastic clamping member, and the pressing base is provided with a first light-transmitting hole corresponding to the light conductor.

7. The light conducting assembly according to claim 6, wherein both the elastic clamping member and the pressing base are made of metal.

8. The light conducting assembly according to claim 6, further comprising an optical effect sheet covering the first light-transmitting hole, wherein an end face of the pressing base away from the elastic clamping member is recessed to form an accommodating groove, and the optical effect sheet is arranged in the accommodating groove.

9. The light conducting assembly according to claim 8, wherein the optical effect sheet is a diffusion sheet.

10. The light conducting assembly according to claim 6, further comprising a fixing sleeve sleeved outside the mounting support, wherein an end of the fixing sleeve is abutted against the pressing base, and the fixing sleeve is provided with a second light-transmitting hole corresponding to the light conductor.

11. A stage light fixture, comprising
a light head, which is internally provided with a light source for emitting a light beam, the light conducting assembly according to claim 1 being arranged in a propagating direction of the light beam;
a support arm pivotally connected to the light head; and
a base pivotally connected to the support arm.
